(19) United States
(12) Patent Application Publication
(10) Pub. No.: US 2006/0093130 A1
(43) Pub. Date: May 4, 2006

(54) Automated access network cross-connect system

(75) Inventor: Timothy L. Kelliher, Alameda, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Alameda, CA (US)

(21) Appl. No.: 11/261,826

(22) Filed: Oct. 28, 2005

Related U.S. Application Data
(60) Provisional application No. 60/623,586, filed on Oct. 28, 2004.

(51) Int. Cl. H04M 3/00; H04M 5/00; H04M 1/00; H04M 7/00; H04M 9/00

(52) U.S. Cl. 379/413.03; 379/326; 379/335

(57) ABSTRACT

A system for automating cross connections in an access network. The automated cross connect system comprises of a plurality of upstream line interface circuits adapted for connection to upstream communication links, and a plurality of downstream line interface circuits adapted for connection to downstream communication links. The upstream and downstream line interface circuits are interconnected by an automated cross connect switch that selectively couples particular upstream line interface circuits to particular downstream line interface circuits, in response to routing commands sent from a command center. Thus, the automated cross connect system selectively establishes a bi-directional communication path between the upstream line interface circuits and the downstream line interface circuits, thereby providing a communication path between a selected upstream communication link and downstream communication link. The automated cross connect switch may be implemented in either a space or time multiplexing devices, such as a physical layer router, which comprises an array of cross connected multiplexers, or a time domain multiplexer switch, which composes an array of serializers connected to a time division multiplexed bus.

### RELATED APPLICATIONS

The present patent application claims priority under 35 U.S.C. §119(e) to U.S. Provisional Patent Application Ser. No. 60/623586, entitled “Automated Access Network Cross-Connect System and Method,” filed Oct. 28, 2004, the full disclosure of which is incorporated herein by reference.

### FIELD

The present invention relates generally to access networks, and more particularly, relates to an automated cross connect system.

### BACKGROUND

The copper based access plant of the public switched telephone network (PSTN) requires multiple manual processes in the activation of new customers and in the trouble shooting of existing customers. Specifically, there are multiple points in the access network where wires are cross connected from one cable to another. In general, telephone cable plants are engineered to allow convenient addition, subtraction, reorganization, and diagnosis on the wires. FIG. 1 is a schematic diagram of a typical prior art access network copper-wiring plant layout 100. In such a network, feeder group 1 cable communication links (F1 cables) 124 run from a central office 102. The F1 cables 124 run to subscriber access interface (SAI) cabinet 104, where feeder group 2 (F2 ) cable communication links (F2 cables) 126 and 128 are cross connected to F1 cable 124. The F2 cables 126 and 128 run to customer terminals (CT) 106 and 108, respectively. F2 cable 128 is cross connected to both subscriber line communication links (subscriber line) 138 and F2 cable 134. Subscriber line 138 runs to individual customer premise location (CP) 116.

The SAI cabinet 104 provides access for a technician to manually connect an F1 cable line 124 to F2 cable line 128, or to perform diagnostics on either the F1 cable 124 or the F2 cable 128. Additionally, CT 106 provides a location for a technician to manually connect F2 cable 128 to subscriber line 138, or to perform diagnostics on either the F2 cable 128 or subscriber line 138.

Typically, when new service is requested at a CP location 116, a technician must first travel from a service office or a previous job location to CP location 116, then to CT 106, and finally to SAI 104. At CP location 116, the technician installs the customer premise equipment and connects it to subscriber line. Then, the technician travels to CT 106 where the upstream end of subscriber line 138 is connected to the downstream end of F2 cable 128. Finally, the technician travels to SAI 104 where the upstream end of F2 cable 128 is connected to the downstream end of F1 cable 124. Even if a service trip for the technician is short, a substantial time investment is required to activate each new customer's service, despite the fact that all necessary wiring already exists within the access network infrastructure.

When the technician is responding to a service problem call at CP 116 with existing service, a technician generally travels to CT 106 to check the connection between the downstream end of F2 cable 128 and the upstream end of subscriber line 138. CT 106 is usually the first place a technician would check because F2 cables tend to fail more frequently than other plant components. If the service problem cannot be fixed there, the technician must then travel to SAI 104 to check the cross connection between the upstream end of F2 cable 128 to the downstream end of F1 cable 124. Again, if the service problem is not identified and corrected there, the technician must then travel to CP location 116 to verify the cross connection between the downstream end subscriber line 138 connection to the customer premise equipment.

Therefore, a device or system of devices that automates and eliminates the recurring manual labor involved in operating an access network would substantially reduce the cost of operations.

### SUMMARY

A system for automating cross connections in an access network is described. The automated cross connect system is comprised of a plurality of upstream line interface circuits adapted for connection to upstream communication links, and a plurality of downstream line interface circuits adapted for connection to downstream communication links. The upstream and downstream line interface circuits are interconnected by an automated cross connect switch that selectively couples particular upstream line interface circuits to particular downstream line interface circuits, in response to routing commands sent from a command center. Thus, the automated cross connect system selectively establishes a bi-directional communication path between the upstream line interface circuits and the downstream line interface circuits, thereby providing a communication path between a selected upstream communication link and downstream communication link.

The automated cross connect system can be implemented in a subscriber access interface cabinet (SAI) to provide SAI cross connects, or in a customer terminal (CT) to provide CT cross connects. When implemented in an SAI, F1 cable communication links are cross connected to F2 cable communication links. When implemented in a CT, F2 cable communication links are cross connected to subscriber line communication links.

The upstream line interface circuits comprise analog to digital converters (ADC), digital to analog converters (DAC), a ring detector circuit, and an off-hook generator circuit, and the downstream line interface circuits comprise analog to digital converters (ADC), digital to analog converters (DAC), an off-hook detector circuit, and a ring generator circuit. The ADC and DAC converters of both the upstream and downstream line interface circuits preferably operate at a frequency below 12 MHz. Preferably, the converters are run off the same clock signal to prevent data slippage.

Subscriber line signaling, including ring signaling and off-hook indications, are also passed through the automated cross connect. For example, when an off-hook signal is generated by one of the downstream line interface circuits, it is routed through the automated cross connect switch to the off-hook generator of the appropriate upstream line interface circuit, such that the upstream line interface circuit generates an off-hook condition on the upstream side of the communication link. For a ring signal, when a ring detect signal is generated by one of the upstream line interface circuits, it is routed through the automated cross connect switch to the ring generator of the appropriate downstream line interface circuit. In response to the ring detect signal, the downstream line interface circuit generates a ring signal that is sent downstream.

In one preferred embodiment, the upstream and downstream line interface circuits are connected to the automated cross connect switch via a bus comprising a downstream bound data line, an upstream bound data line, a hook line for transferring an off-hook detect signal, and a ring line for transferring ring detect signal.

The automated cross connect switch is configured by routing commands preferably provided from a central office. The routing commands may be provided to the automated cross connect switch using out-of-band signaling over the existing communication link cables, over a dedicated wired or wireless connection.

In some preferred embodiments, the automated cross connect system further comprises a plurality of digital filters that function as a digital signal splitter, such that the plurality of digital filters separate lower frequency signals from higher frequency signals.

Thus, the data that is digitized by the downstream line interface circuits includes low frequency analog signals, high frequency analog signals, and an off-hook signal.

In on preferred embodiment, the automated cross connect switch takes the form of a physical layer router (PLR). The PLR comprises a plurality of upstream multiplexers, a plurality of downstream multiplexers, and a routing controller that configures the upstream multiplexers and downstream multiplexers to selectively establish communication paths between ones of the upstream line interface circuits and the downstream line interface circuits.

In one embodiment, the upstream and downstream multiplexers have a multiplexed port and a plurality of demultiplexed ports. The multiplexed ports of the upstream and downstream multiplexers are connected to individual ones of the upstream and downstream line interface circuits, respectively, and the de-multiplexed ports of the upstream and downstream multiplexers are interconnected with each other.

The multiplexers provide data paths for a number of lines, thus each of the ports are preferably data buses comprising a downstream bound data line, an upstream bound data line, a hook line for transferring an off-hook detect signal, and a ring line for transferring a ring detect signal. The multiplexers thus provide for bi-directional data flow. The multiplexers can be either bi-directional, or may be constructed from a pair of unidirectional multiplexers configured jointly to provide bi-directional data flow. In an alternative embodiment, the multiplexers may provide for serial transmission of data, where the hook signal, ring signal, and sample data are serialized for transmission through the cross connect switch multiplexers.

The number of demultiplexed ports on the upstream multiplexers is preferably equal to the number of downstream multiplexers or downstream communication links, and the number of demultiplexed ports on the downstream multiplexers is equal to the number of upstream multiplexers or upstream communication links, as determined by the cabling infrastructure needs.

The automated cross connect switch may also take the form of a time domain multiplexer switch. The time domain multiplexer switch comprises at least one upstream serializer, at least one downstream serializer, and a time division multiplexed (TDM) bus. The upstream serializer is connected to corresponding upstream line interface circuits and the downstream serializer is connected to corresponding downstream line interface circuits, and the upstream serializer and downstream serializer are interconnected via a time division multiplexed bus.

The TDM bus may have a number of time slots for transmission of N (the number of upstream lines) +M (the number of downstream lines), thereby providing dedicated, or predetermined, transmission slots for the serializers. As an alternative, the bus may be configured to have 2N time slots: N slots each for the upstream and downstream serializers. In this embodiment, the downstream serializers would be dynamically configured to transmit during the appropriate downstream transmission time slots. Alternatively, the TDM bus may actually have a separate upstream transmission bus and downstream transmission bus. In this preferred embodiment, the upstream transmission bus may be configured to have N time slots, while the downstream transmission bus may have either M (dedicated) or N (dynamically assigned) time slots.

The system provides for automating cross connections and diagnostics in a telecommunications system and/or other access network that automates manual cross connect/diagnostic functions that are currently extremely labor intensive. Rather than requiring a technician to manually connect upstream communication link 308 to downstream communication link 310, the automated cross connect system allows a technician in the central office to remotely establish a connection between upstream and downstream communication links. This saves the time and expense of a technician traveling on-site to physically make the connection.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a schematic diagram of a typical prior art access network wiring plant layout, according to an example;

FIG. 2 is a schematic diagram of an access network wiring plant layout incorporating the automated cross-connect equipment, according to an example;

FIGS. 3A and 3B are schematic diagrams of an automated cross connect system, according to an example;

FIG. 4A is a schematic diagram of an upstream line interface circuit according to an example;

FIG. 4B is a schematic diagram of a downstream line interface circuit, according to an example;

FIGS. 5A and 5B are schematic diagrams of an automated cross connect system according to a physical layer router embodiment, according to an example;

FIGS. 6A and 6B are schematic diagrams of a physical layer router, according to an example;

FIGS. 7A and 7B are schematic diagrams of an automated cross connect system according to a time domain multiplexer switch embodiment, according to an example;

FIG. 8 is a schematic diagram of a time domain multiplexer switch;

FIGS. 9A and 9B are schematic diagrams of a time domain multiplexed bus of the time domain multiplexer switch;

FIG. 10 is a schematic diagram of an automated cross connect system incorporating the use of digital filters.

### DETAILED DESCRIPTION

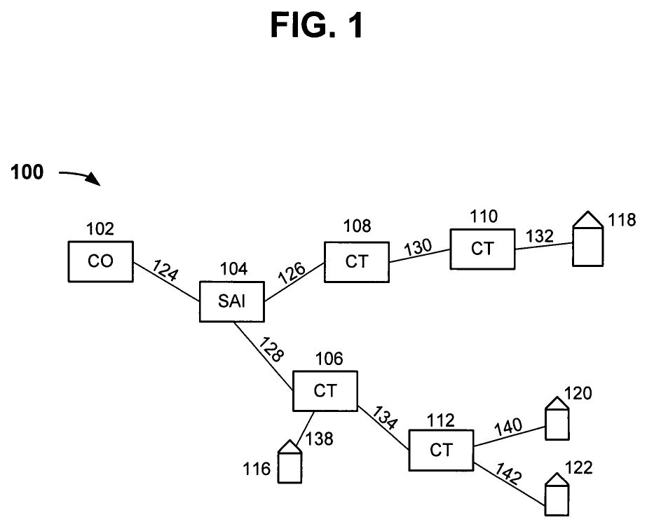

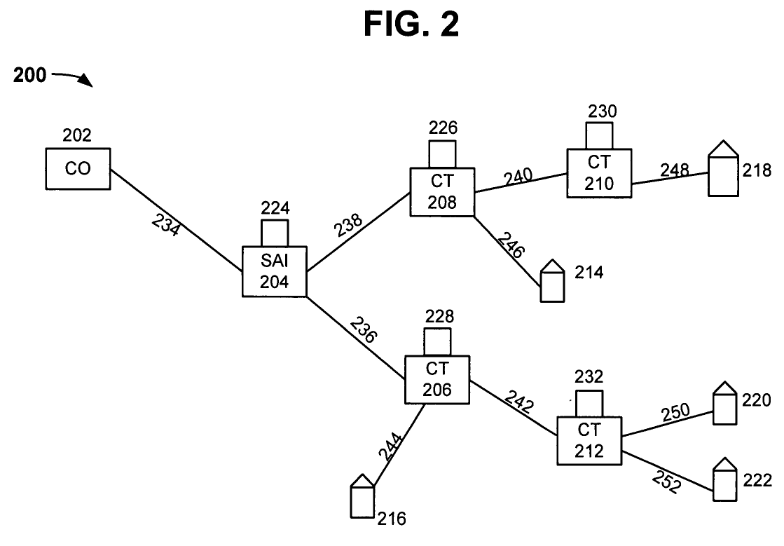

FIG. 2 is a diagram of an access network wiring plant layout 200 incorporating the automated cross-connect equipment. By way of example, SAI 204 includes an automated cross connect switch 224 and CTs 206, 208, 210, and 212 also include an automated cross connect switches 226, 228, 230, and 232 respectively. The system described herein replaces the hard-wired cross-connects used in prior art SAI and CT installations (see FIG. 1) with one or more automated cross connect switches such that F1 cable 234, F2 cables 236, 238, 240, and 242, and subscriber lines 242, 244, 246, 248, 250, and 252 can be selectively coupled to establish a communication path, without requiring manual configuration. This and other examples are described in greater detail below.

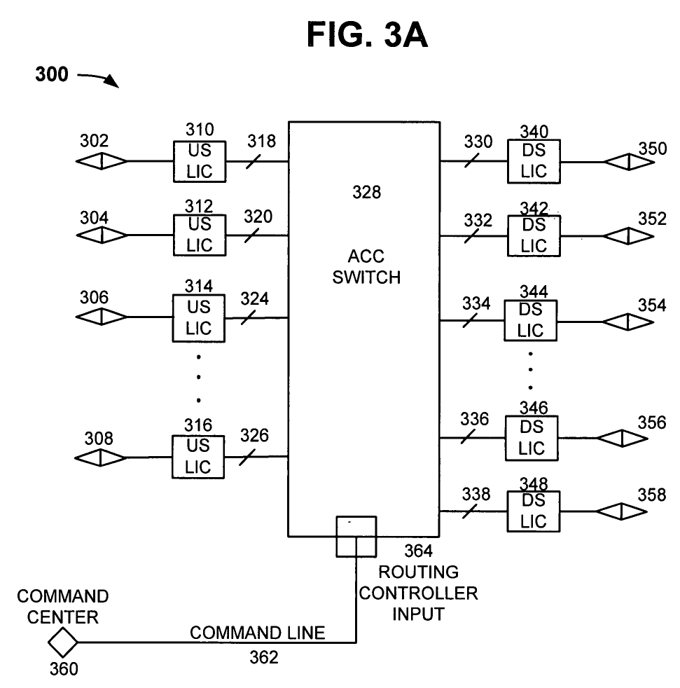

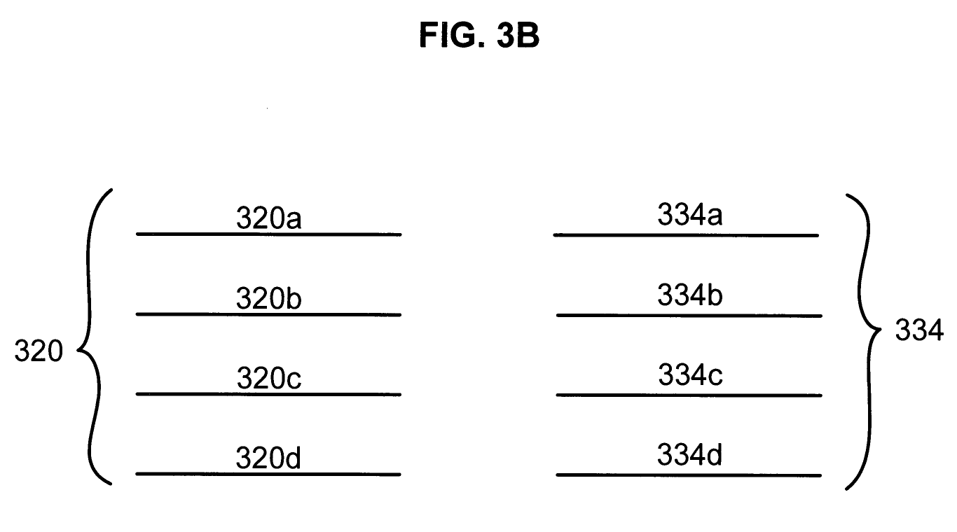

FIG. 3A is a diagram of an automated cross connect system 300. A plurality of upstream communication links 302, 304, 306, and 308 are individually routed to a plurality of upstream line interface circuits 310, 312, 314, and 316, respectively. As used hence forth, the upstream direction refers to data flow towards the central office, and the downstream direction refers to data flow towards the customer premise locations. The upstream line interface circuits 310, 312, 314, and 316 are routed to the upstream side of automated cross-connect (ACC) switch 328 via upstream communication buses 318, 320, 324, 326. Referring to FIG. 3B, upstream communication bus 320 comprises downstream bound data line 320a, upstream bound data line 320b, hook line 320c, and ring line 320d. The downstream side of ACC switch 328 is connected to downstream line interface circuits 340, 342, 344, 346, and 348 via downstream communication buses 330, 332, 334, 336, and 338, respectively.

Referring to FIG. 3B, downstream communication bus 334 comprises downstream bound data line 334a, upstream bound data line 334b, hook line 334c, and ring line 334d. ACC switch 328 routes upstream communication buses 318, 320, 324, and 326 for a particular upstream line interface circuit to one of the desired downstream data buses 330, 332, 334, 336, 338. The downstream line interface circuits 340, 342, 344, 346, and 348 are provide connections to downstream communication links 350, 352, 354, 356, and 358, respectively. In addition, command center 360 is connected to routing controller input 364 of ACC switch 328 via command line 362. The routing controller of ACC switch 328 provides routing commands sent along command line 362 to ACC switch 328. The routing controller may provide for configuration data re-formatting as necessary, such as if the configuration data is provided over a TCP link, or out of band signaling, and subsequently converted into a format suitable for configuring the ACC switch using multiplexers, a TDM bus, or other alternative structure.

ACC switch 328 selectively couples upstream line interface circuits to desired downstream line interface circuits in response to routing commands sent along command line 362. The data flows bi-directionally in the upstream and downstream direction. In this context, the upstream and downstream line interface circuits are coupled, meaning that data can be routed from an upstream line interface circuit to a downstream line interface circuit, and vice-versa. In addition, the plurality of upstream and downstream line interface circuits, as well as ACC switch 328, are all clocked by a common source clock to prevent data slippage. Thereby, ACC switch 328 selectively establishes a bi-directional communication path between a particular upstream communication link and a downstream communication link in a way that prevents data slippage.

In one preferred embodiment, routing commands being sent to command line 362 may originate from a central office. Routing commands may be sent to command line 328 via wireless link, Ethernet connection, or other suitable signaling mechanism. In yet another embodiment, a local interface may be provided on ACC switch 328 to allow a technician to run diagnostics or provide configuration data. In addition, routing commands sent to routing controller input 364 may be in SNMP protocol carried over TCP/IP, frame relay, or a proprietary protocol. Furthermore, the routing commands may comprise out-of-band signaling sent over the subscriber communication cabling infrastructure to avoid interference with data being cross connected in ACC switch 328.

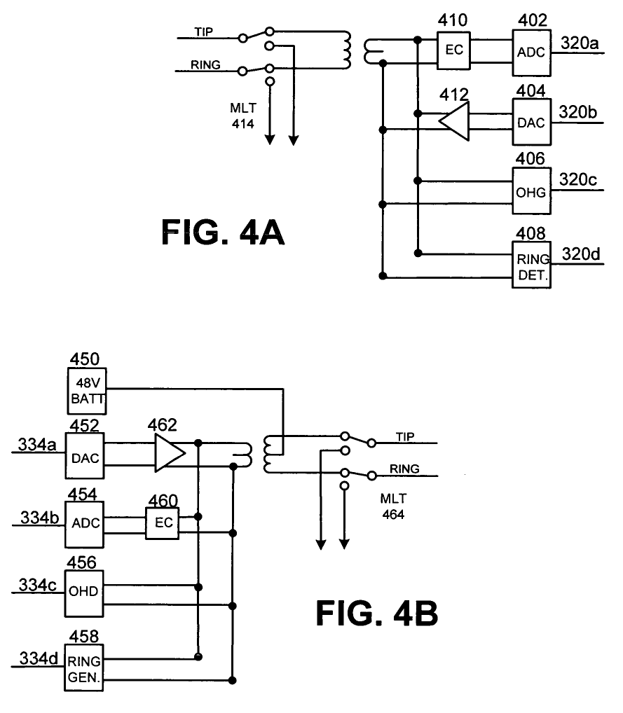

With respect to FIGS. 4A and 4B, an exemplary data flow will be described. The analog data originating from upstream communication link 304 is routed to upstream line interface circuit 312. At upstream line interface circuit 312, metallic loop test (MLT) bypass relay 414 routes the analog data to analog to digital converter (ADC) 402. At ADC 402, the data is converted into digital format, and the digitized data is then routed to ACC Switch 328 via downstream bound data line 320a. Supposing the routing command from command line 362 instructs the ACC switch to establish a communication path between upstream line interface circuit 312 and downstream line interface circuit 344. ACC switch 328 configures itself such that the digitized data on downstream bound data line 320a of upstream communication bus 320 is routed to downstream bound data line 334a of downstream communication bus 334. The data on downstream bound data line 334a is then provided to the digital to analog converter (DAC) 452 of downstream line interface circuit 344, where it is converted back to an analog signal. The ADC 402 and DAC 452 preferably operate at a sampling frequency below 12 Mhz. The analog data is then passed through MLT bypass relay 464 where it is then routed to downstream communication link 354.

The downstream line interface circuit also contains an echo canceller (EC) 460 to prevent feedback of the downstream signal back in the upstream direction. EC 460 may be implemented in the form of a standard 4 wire/2 wire hybrid circuit, or may be implemented digitally, wherein a digital local echo replica signal is subtracted from the digitally sampled input signal, as is known to those of skill in the art.

For analog signals on the downstream communication link 354 that are upstream bound, the analog signals are routed to downstream line interface circuit 344. The analog signal is routed to ADC 454 via MLT bypass relay 464, where it is converted to a digital format. Once the signal is digitized, it is routed to ACC switch 328 via upstream bound data line 334b of downstream communication bus 334. Again, if ACC switch 328 is selectively configured to establish a communication path between downstream line interface circuit 344 and upstream line interface circuit 312, ACC switch 328 connects upstream bound data line 334b of downstream communication bus 334 to upstream bound data line 320b of upstream communication bus 320. The digitized data is then routed to DAC 404 of upstream line interface circuit 312 via upstream bound data line 320a. There, the data is converted back to an analog signal format. The analog signal is then routed to upstream communication link 304 after it passes through MLT bypass relay 414. Note that upstream line interface circuit 312 also preferably contains EC 410 to prevent echoes.

When a ring signal is sent on upstream communication link 302 to upstream line interface circuit 312, then the ring signal is detected by ring detector circuit 408 of upstream line interface circuit 312. When ring detector circuit 408 detects a ring signal from upstream communication link 302, ring detector circuit 408 sends a ring detect signal along ring line 320d of upstream communication bus 320. ACC switch 328 couples upstream line interface circuit 312 to downstream line interface circuit 344. As such, ring line 320d of upstream communication bus 320 will be connected to ring line 334d of downstream communication bus 334, such that the ring detect signal is routed to ring generator circuit 458 of downstream line interface circuit 344. Ring generator circuit 458 then produces a ring signal in response to the ring detect signal of ring detector circuit 408. The ring signal is then passed through MLT bypass relay 464, and is sent to downstream communication link 354.

When an off-hook signal is sent upstream along downstream communication link 354, the off-hook signal is detected by off-hook detector circuit 456. In preferred embodiments, the off-hook detector circuit 456 detects the presence of a line current typically caused by customer premise equipment providing a loop termination impedance. The off-hook detector circuit 456 then produces an off-hook detect signal which is routed to ACC switch 328 via hook line 334c of downstream communication bus 334. ACC switch 328 is configured to connect hook line 334c of downstream communication bus 334 to hook line 320c of upstream communication bus 320, wherein the off-hook detect signal on hook line 320c is then routed to off-hook generator circuit 406, which responsively produces an off-hook signal condition. The off-hook signal from off-hook generator circuit 406 is passed through MLT bypass relay 414, where it is routed to upstream communication link 304. In preferred embodiments, the off hook condition is generated by providing a loop termination impedance across the upstream communication link, thereby causing a loop current to flow in the upstream communication link. Such an impedance may be provided by closing a switch controlled by off-hook generator 406.

ACC switch 328 can be employed in either SAI 204 to provide subscriber access interface cross connects, or CTs 206, 208, 210, and 212 to provide customer terminal cross connects. In an SAI implementation, the upstream communication links are preferably F1 cables 234, and the downstream communication links are preferably F2 cables 236 and 238. In a CT implementation, the upstream communication links are preferably F2 cables 236, 238, 240, and 242, and the downstream communication links are preferably subscriber lines 244, 246, 248, 250, and 252. Except for differences in the number of cables connected at SAI 204 and CTs 206, 208, 210, and 212, a SAI installation operates the same as a CT installation.

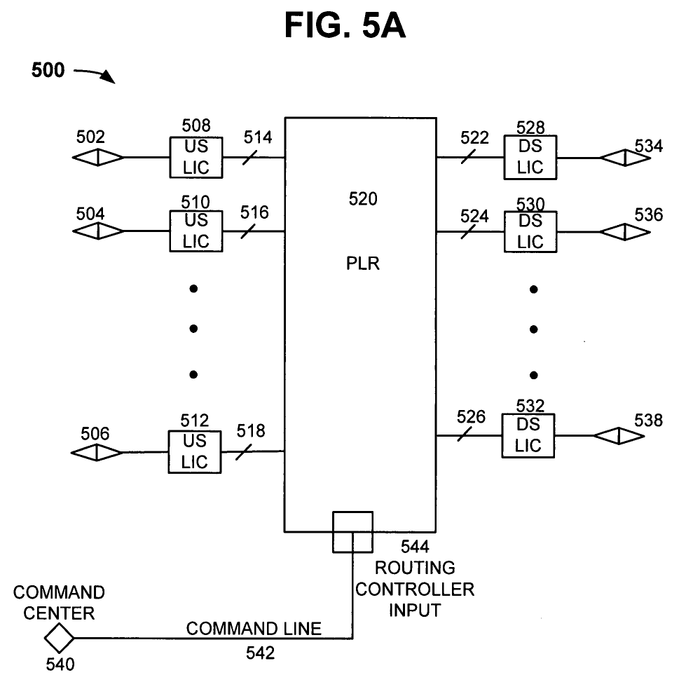

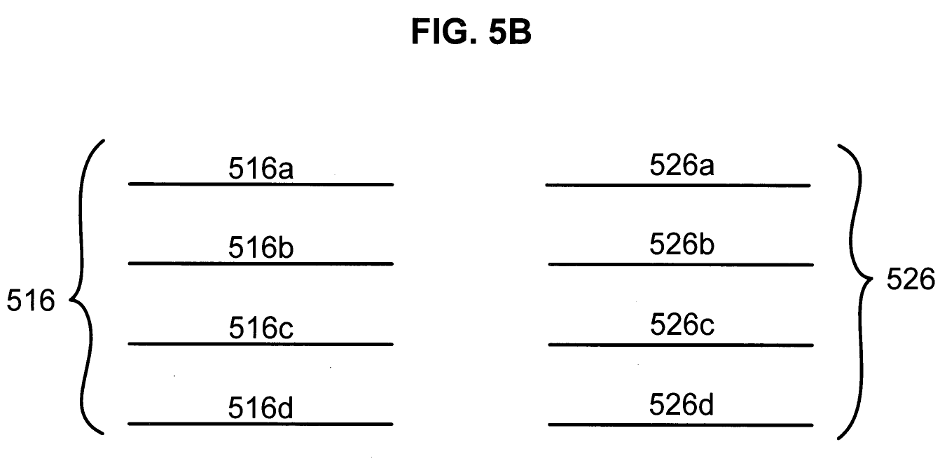

FIG. 5A depicts one preferred embodiment where ACC switch 302 comprises a physical layer router (PLR) 520. PLR 520 is described in U.S. Pat. No. 6,839,343, the disclosure of which has been incorporated herein by reference.

PLR 520 selectively couples a particular upstream line interface circuit to a particular downstream line interface circuit in response to routing commands sent along command line 362, such that data can flow bi-directionally in the both the upstream and downstream direction. As noted above, coupling in this context means that data can be routed from an upstream line interface circuit to a downstream line interface circuit, and vice-versa. In addition, the plurality of upstream and downstream line interface circuits are all clocked by a common source clock to prevent data slippage. Thereby, PLR 520 selectively establishes a bi-directional communication path between particular upstream communication links and desired downstream communication links in a way that prevents data slippage.

FIG. 5A contains upstream communication links 502, 504, and 506 routed to upstream line interface circuits 508, 510, and 512, respectively. Upstream line interface circuits 508, 510, and 512 are routed to the upstream side of PLR 520 via upstream communication buses 514, 516, and 518. As depicted in FIG. 5B, upstream communication bus 516 comprises downstream bound data line 516a, upstream bound data line 516b, hook line 516c, and ring line 516d. Downstream communication buses 522, 524, and 526 connect the downstream side of PLR 520 to downstream line interface circuits 528, 530, and 532, respectively. As depicted in FIG. 5B, downstream communication bus 526 comprises downstream bound data line 526a, upstream bound data line 526b, hook line 516c, and ring line 516d. Downstream line interface circuits 528, 530, and 532 are connected to downstream communication links 534, 536, and 538, respectively. Command line 542 routes routing commands from command center 540 to routing controller input 544 of PLR 520. Data flow of FIG. 5A is similar to data flow of FIG. 3A.

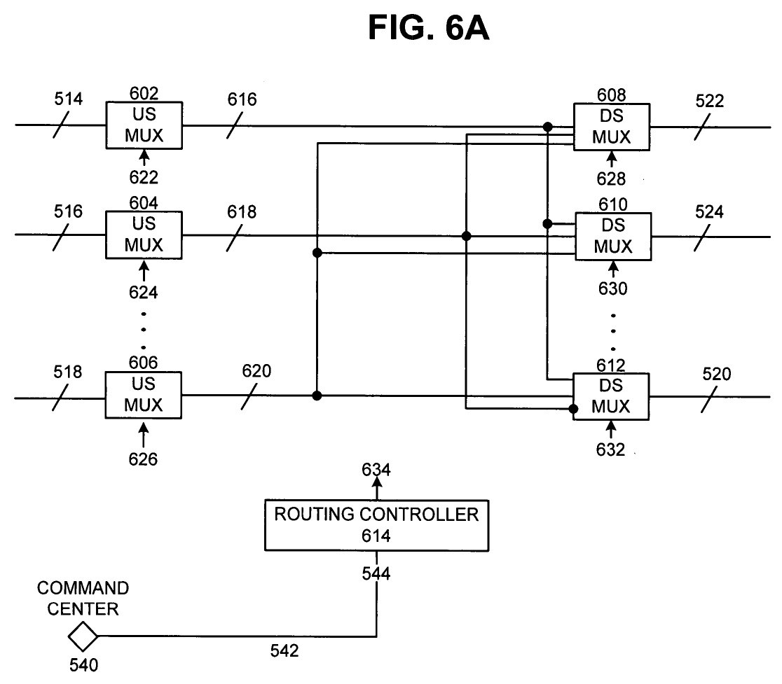

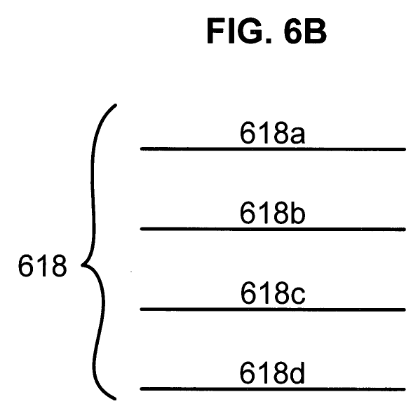

FIG. 6A is a diagram 600 of PLR 520. As depicted, PLR 520 comprises an array of upstream multiplexers (MUXs) 602, 604, and 606, and downstream MUXs 608, 610, and 612. The array of upstream and downstream MUXs are preferably bi-directional to allow data to flow in both the upstream and downstream direction. In an alternative embodiment, the MUXs are uni-directional MUXs interconnected in such a way to allow data to flow in both directions. Upstream communication buses 514, 516, and 518 are routed to the multiplexed ports of upstream MUXs 602, 604, and 606, respectively. The de-multiplexed ports of upstream MUXs 602, 604, and 606 are interconnected to the de-multiplexed ports of each and every downstream MUX 608, 610, and 612 via de-multiplexed buses 616, 618, and 620. As depicted in FIG. 6B, de-multiplexed bus 618 comprises downstream bound data line 618a, upstream bound data line 618b, hook line 618c, and ring line 618d. The multiplexed ports of downstream MUXs 608, 610, and 612 are routed to downstream communication buses 522, 524, and 526, respectively. PLR 520 also comprises routing controller 614, which receives routing commands from command line 542 via routing controller input 544. Select line 634 from routing controller 614 provides select inputs 622, 624 and 626 of upstream MUXs 602, 604, and 606, respectively, and to select inputs 628, 630, and 632 of downstream MUXs 608, 610, and 612.

With respect to FIG. 6A, an exemplary data flow will be described. Signals from upstream communication bus 516 are routed to upstream MUX 604. If upstream line interface circuit 510 (refer to FIG. 5A) and downstream line interface circuit 532 are to be interconnected, PLR 520 is configured by sending configuration commands on select line 634 to select input 624 of upstream MUX 604 and select input 632 of downstream MUX 612. Thereby, a communication path is established between the multiplexed ports 516, 520, of upstream MUX 604 and downstream MUX 612. The data or signal sent to upstream MUX 604 is then routed to downstream MUX 612, where it is routed to downstream line interface circuit 532.

If sample data or a hook signal is sent upstream along downstream communication bus 526, that data or signal is routed to downstream MUX 612. If PLR 520 is directed to selectively establish a communication path between downstream line interface circuit 532 (refer to FIG. 5A) and upstream line interface circuit 510 (refer to FIG. 5), then routing controller 614 will send configuration data along select line 634 to select input 632 of downstream MUX 612 and select input 624 of upstream MUX 604. Thereby, a communication path is established between downstream MUX 612 and upstream MUX 604. The data or signal sent to downstream MUX 612 is then routed to upstream MUX 604, where it is then sent along upstream communication bus 516.

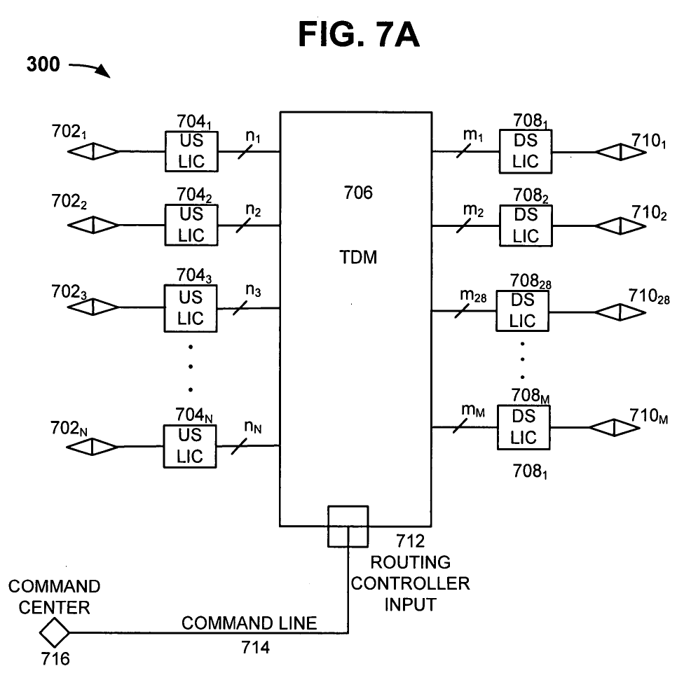

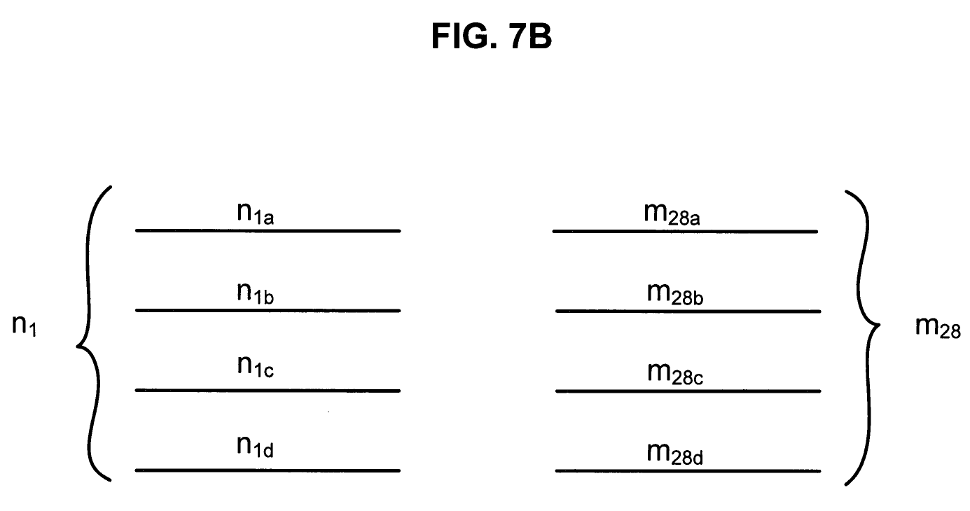

FIG. 7A is another preferred embodiment, where ACC switch 302 comprises a time domain multiplexer (TDM) switch 706. TDM switch 706 selectively couples a particular upstream line interface circuit to a particular downstream line interface circuit in response to routing commands sent along command line 714, such that data can flow bi-directionally in the both the upstream and downstream direction. As noted above, coupling in this context means that data can be routed from an upstream line interface circuit to a downstream line interface circuit, and vice-versa. In addition, the plurality of upstream and downstream line interface circuits, as well as TDM switch 706, are all clocked by a common source clock to prevent data slippage. Thereby, TDM switch 706 selectively establishes a bi-directional communication path between a particular upstream communication link and a downstream communication link in a way that prevents data slippage.

Similar to FIG. 3A, FIG. 7A contains upstream communication links 702₁, 702₂, 702₃, through 702_{N}, routed to upstream line interface circuits 704₁, 704₂, 704₃, through 704_{N}, respectively. Upstream line interface circuits 704₁, 704₂, 704₃, through 704_{N} are routed to the upstream side of TDM switch 706 via upstream communication buses n₁, n₂, n₃, through n_{N}. As depicted in FIG. 7B, upstream communication bus n₁ comprises downstream bound data line n₁ₐ, upstream bound data line n_{1b}, hook line n_{1c}, and ring line n_{1d}. Downstream communication buses m₁, m₂, m₂₈, through m_{M} connect the downstream side of TDM switch 706 to downstream line interface circuits 708₁, 708₂, 708₂₈, through 708_{M}, respectively. As depicted in FIG. 7B, downstream communication bus m₂₈ comprises downstream bound data line m₂₈ₐ, upstream bound data line m_{28b}, hook line m_{28c}, and ring line m_{28d}. Downstream line interface circuits 708₁, 708₂, 708₂₈, through 708_{M} are connected to downstream communication links 710₁, 710₂, 710₂₈, through 710_{M}, respectively. Command line 714 routes routing commands from command center 716 to routing controller input 712 of TDM switch 706. Data flow of FIG. 7A is similar to data flow of FIG. 3A.

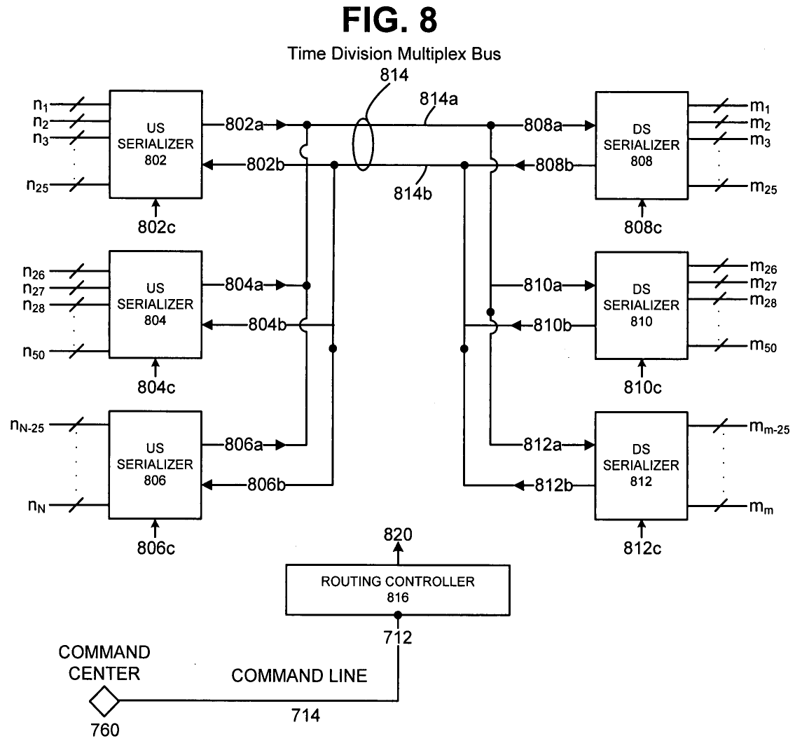

FIG. 8 is a schematic diagram 800 of TDM switch 706. As depicted, TDM switch 706 comprises an array of upstream serializers 802, 804, and 806, and downstream serializers 808, 810, and 812. Although labeled as serializers, upstream serializers 802, 804, and 806, and downstream serializers 808, 810, and 812 function as both serializers and deserializers to allow data to flow bi-directionally. As depicted in FIG. 8, upstream serializers 802, 804, and 806, and downstream serializers 808, 810, and 812 are preferably all 25 port serializers, meaning they have 25 inputs. However, the upstream and downstream serializers can have any number of input ports. Upstream serializer 802 has as inputs upstream communication buses n₁ through n₂₅. Upstream serializer 804 has as inputs upstream communication buses n₂₆ through n₅₀. Upstream serializer 806 has as inputs upstream communication buses n_{N-25} through n_{N}. The downstream bound outputs of upstream serializers 802, 804, and 806 are serial data lines 802a, 804a, and 806a, respectively, and comprise the upstream portion of time division multiplexed bus 814, or simply upstream TDM bus 814a.

Similarly, the upstream bound outputs of downstream serializers 808, 810, and 812 comprise the downstream time division multiplexed bus 814b, and comprise serial data lines 808b, 810b, and 812b, respectively. Data that is upstream bound is routed to the time division multiplexed bus 814 where it is sent to upstream serializers 802, 804, and 806 via serial data lines 802b, 804b, and 806b, respectively (also part of the downstream TDM bus). Select line 820 of routing controller 816 is routed to select inputs 802c, 804c, 806c of upstream serializers 802, 804, and 806, respectively, and to select inputs 808c, 810c, and 812c of downstream serializers 808, 810, and 812. Routing commands are sent to routing controller input 712 of routing controller 816 from command center 716 via command line 714. The outputs of downstream serializer 808 are downstream communication buses m₁ through m₂₅. The outputs of downstream serializer 810 are downstream communication buses m₂₆ through m₅₀. The outputs of downstream serializer 812 are downstream communication buses m_{M-25} through m_{M}.

The upstream TDM bus 814a is preferably configured to have N time slots, while downstream TDM bus 814b is preferably configured to have M time slots. Preferably, M is greater than N as a result of the cable infrastructure configuration, but only N active communication links are established at any time. Thus, not all M downstream time slots will be in use at one time; however, by providing M time slots, each downstream link may be mapped to a dedicated, or predetermined, time slot. Alternatively, downstream TDM bus 814b may be configured to have only N time slots, and the downstream serializers may be dynamically configured (via routing commands) to transmit in the appropriate time slot.

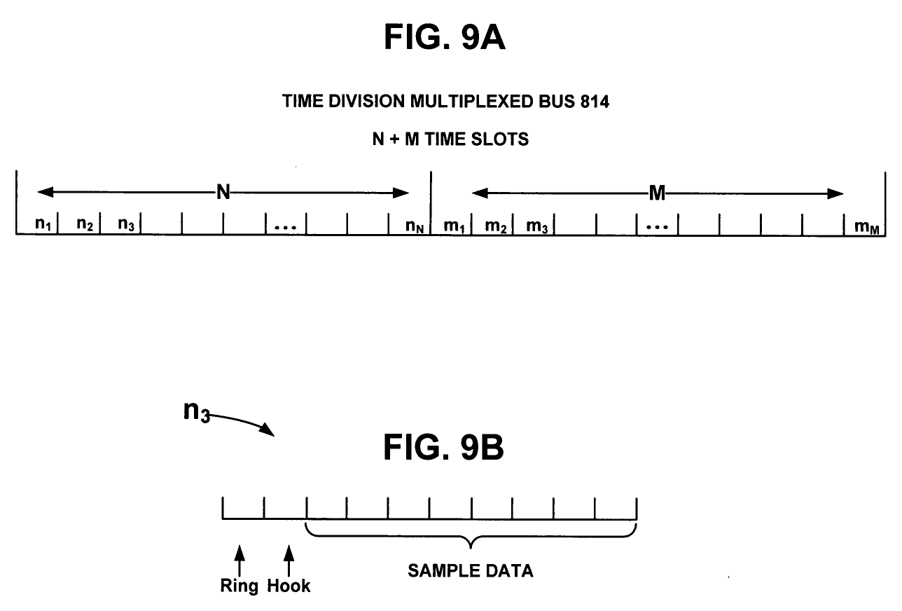

As a further alternative, the TDM bus 814 may be a single shared bidirectional bus. Referring to FIG. 9A, time division multiplexed bus has N+M time slots, such that every 25 port upstream and downstream serializer is assigned 25 slots during which they transmit their data onto the time division multiplexed bus 814. The time slots can be arranged in any order, but FIG. 9A depicts the time slots arranged such that the N upstream inputs are assigned to the first N time slots, and the M downstream outputs are assigned to the last M time slots. In this embodiment, all the upstream and downstream serializers are all interconnected over a single shared bidirectional bus. As a further alternative, the TDM bus may provide only 2N time slots, wherein the downstream serializers are dynamically configured to transmit in the appropriate time slots.

Referring to FIG. 8, an exemplary data flow will be described wherein upstream communication bus n₃ and downstream communication bus m₂₈ are configured by routing controller 816 to send and receive data. Downstream bound data sent along upstream communication bus n₃ is routed to input port 3 of upstream serializer 802. At upstream serializer 802, the data is quantized into serial bit-stream form. Referring again to FIG. 9A, the quantized data of upstream communication bus n₃ is transmitted from upstream serializer 502 to time slot n₃ of time division multiplexed bus 814 during an upstream time slot. According to FIG. 9B, time slot n₃ has 10 bits: 1 bit for ring data, 1 bit for hook data, and 8 bits for sample data. However, sample data could be greater than 8 bits, such as 12 bits or 16 bits for example, depending on the tolerance desired for quantization error. Downstream serializer 810 is configured by routing controller 816 to read data from time slot n₃. Once downstream serializer 810 reads the data on time slot n₃, it then deserializes and routes the data downstream via downstream communication bus m₂₈. Similarly, upstream bound data along downstream communication bus m₂₈ is routed to the third port of downstream serializer 810. At downstream serializer 810, the data is quantized into serial bit-stream form. Downstream serializer 810 then transmits the quantized data of downstream communication bus m₂₈ in time slot m₂₈ of time division multiplexed bus 814 during a downstream time slot. Upstream serializer 802 is configured by routing controller 816 to read data from time slot m₂₈. Once upstream serializer 802 reads the data on time slot m₂₈, it then deserializes and routes the data upstream via upstream communication bus n₃.

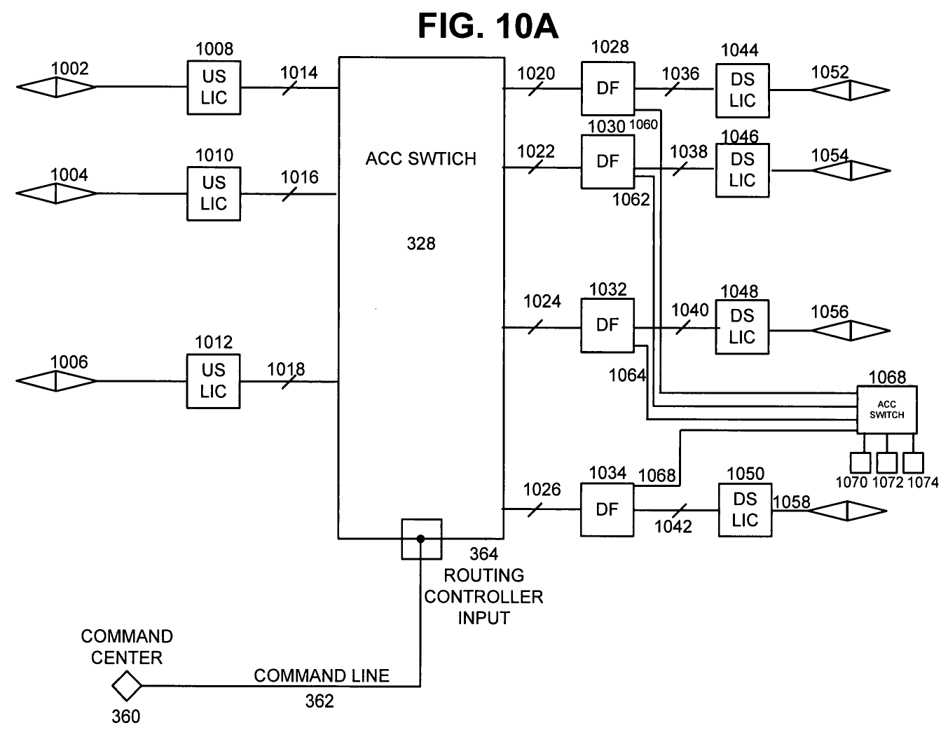

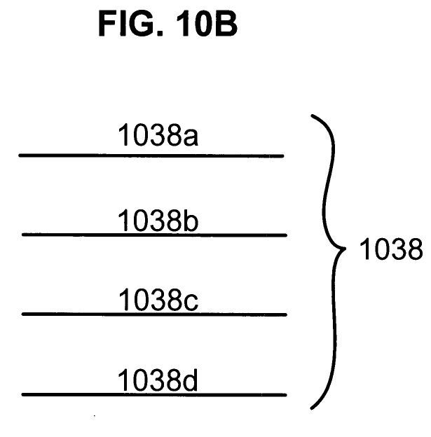

FIG. 10 is a schematic diagram of an automated cross connect system incorporating the use of digital filters. As depicted in FIG. 10, upstream communication links 1002, 1004, and 1006 are routed to upstream line interface circuits 1008, 1010, and 1012 respectively. Upstream line interface circuits 1014, 1016, and 1018 are connected to the upstream side of ACC Switch 328 via upstream communication buses 1014, 1016, and 1018. The downstream side of ACC Switch 328 is routed to digital filters 1028, 1030, 1032, and 1034 via downstream communication buses 1020, 1022, 1024, and 1026. The low frequency signals passing through DFs 1028, 1030, 1032, and 1034 are routed to downstream line interface circuits 1044, 1046, 1048, and 1050, via low frequency buses 1036, 1038, 1040, and 1042, respectively.

As depicted in FIG. 10B, low frequency bus 1038 comprises downstream bound data line 1038a, upstream bound data line 1038b, hook line 1038c, and ring line 1038d. Downstream line interface circuits 1044, 1046, 1048, and 1050 are then routed to downstream communication links 1052, 1054, 1056, and 1058, respectively. The high frequency signals passing through DFs 1028, 1030, 1032, and 1034 are routed to ACC Switch 328 via high frequency lines 1060, 1062, 1064, and 1068, respectively. ACC Switch 328 is then connected to digital signal processor (DSP) pool 1070, 1072, and 1074. In addition, command center 360 is connected to routing controller input 364 of ACC Switch 328 via command line 362.

DFs 1028, 1030, 1032, and 1034 function as digital signal splitters, allowing lower frequency voice signals to pass through to downstream line interface circuits 1044, 1046, 1048, and 1050 via low frequency buses 1036, 1038, 1040, and 1040, respectively, but route high frequency data signals to a DSP (not shown). In the embodiment shown, all DFs 1028, 1030, 1032, and 1034 route high frequency signals to ACC Switch 328, which is connected to a pool of DSPs 1070, 1072, and 1074. In this manner taught by U.S. Pat. No. 6,839,343 B2 (referenced and incorporated previously), a pool of DSL modems or DSPs provide DSL service to a larger number of downstream lines. This embodiment may be used in a SAI, or alternatively at a CT.

The automated cross connect system described herein provides a system to install new service and to trouble shooting existing service. Instead of requiring a technician to drive to multiple sites, a technician from a remote location may send a routing commands to the SAI and CTs equipped with the automated cross connect switches to connect new service. These commands will direct that the correct connections be made between F1 cables and F2 cables at the SAI and between F2 lines and subscriber lines at the CT. As such, the technician is not required to physically visit the SAI and/or CT.

Similarly, for a trouble shooting application, the technician may isolate each branch of the access network between central office and the customer premise location using the local MLT bypass circuits in each line interface circuit. This accomplishes the same circuit test that a technician would perform by physically visiting the site with a handheld portable test unit (“butt set”). Each line may be isolated or connected back on itself to check for circuit integrity. At the CT, a number of open-ended tests may be accomplished can be performed by a technician with a voltmeter, including taking voltage, resistance, and capacitance measurements. The CT and/or the SAI may optionally have a standard voltmeter built into the circuitry such that circuits may be remotely tested by rearranging the connections in a manner that would be readily understandable by one of skill in the art upon reading the foregoing description.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

1. A system for automating cross connections in an access network comprising:
a plurality of upstream line interface circuits adapted for connection to upstream communication links;
a plurality of downstream line interface circuits adapted for connection to downstream communication links;
an automated cross connect switch between the said plurality of upstream line interface circuits and said plurality of downstream line interface circuits for selectively coupling ones of the plurality of upstream line interface circuits to ones of the plurality of downstream line interface circuits, in response to routing commands; and
wherein a bi-directional communication path is selectively established between ones of the plurality of upstream line interface circuits and ones of the plurality of downstream line interface circuits.

2. The system of claim 1, wherein the automated cross connect system provides subscriber access interface cross connects and wherein the said subscriber access interface cross connects are adapted for connection to F1 cable communication links and F2 cable communication links.

3. The system of claim 1, wherein the automated cross connect system provides customer terminal cross connects, wherein the customer terminal cross connects are adapted for connection to F2 cable communication links and subscriber line communication links.

4. The system of claim 1, wherein each of the plurality of upstream line interface circuits comprise a data converters, a ring detector circuit, and an off-hook generator circuit.

5. The system of claim 1, wherein each of the plurality of downstream line interface circuits comprise a data converters, an off-hook detector circuit, and a ring generator circuit.

6. The system of claim 1, wherein an off-hook signal is generated by one of the plurality of downstream line interface circuits, and wherein the said off-hook signal is routed through the automated cross connect switch to the appropriate one of the plurality of upstream line interface circuits, and wherein the said appropriate upstream line interface circuit generates an off-hook generator signal.

7. The system of claim 1, wherein a ring detect signal is generated by one of the plurality of upstream line interface circuits, and wherein the said ring detect signal is routed through the automated cross connect switch to the appropriate one of the plurality of downstream line interface circuits, and wherein the said appropriate downstream line interface circuit generates a ring signal.

8. The system of claim 1, wherein routing commands are provided to the automated cross connect switch from a central office.

9. The system of claim 8, wherein the routing commands are provided to the automated cross connect switch using out-of-band signaling.

10. The system of claim 1, wherein the plurality of upstream line interface circuits and the plurality of downstream line interface circuits are clocked off of a single clock source to prevent data slippage.

11. The system of claim 1, wherein the plurality of upstream line interface circuits and the plurality of downstream line interface circuits are connected to the said automated cross connect switch via a bus comprising a downstream bound data line, an upstream bound data line, a hook line for transferring an off-hook detect signal, and a ring line for transferring ring detect signal.

12. The system of claim 1, wherein the automated cross connect system further comprises a plurality of digital filters that function as a digital signal splitter, such that the plurality of digital filters separate lower frequency signals from higher frequency signals.

13. The system of claim 1, wherein data that is digitized by the said plurality of downstream line interface circuits includes low frequency voice-band analog signals and high frequency data service analog signals.

14. The system of claim 1, wherein the automated cross connect switch comprises a physical layer router, wherein the physical layer router comprises a plurality of upstream multiplexers, a plurality of downstream multiplexers, and a routing controller that configures the said plurality of upstream multiplexers and the said plurality of downstream multiplexers to selectively establish a communication path between ones of the plurality of upstream line interface circuits and ones of the plurality of downstream line interface circuits.

15. The system of claim 14, wherein each of the plurality of upstream and downstream multiplexers comprise a multiplexed port and a plurality of demultiplexed ports, and wherein the multiplexed ports of the plurality of upstream and downstream multiplexers are connected to corresponding ones of the plurality of upstream line interface circuits and to corresponding ones of the plurality of downstream line interface circuits, and wherein the de-multiplexed ports of the plurality of upstream and downstream multiplexers are interconnected between the plurality of upstream multiplexers and the plurality of downstream multiplexers.

16. The system of claim 14, wherein the multiplexed ports and de-multiplexed ports are data buses comprising a downstream bound data line, an upstream bound data line, a hook line for transferring an off-hook detect signal, and a ring line for transferring a ring detect signal.

17. The system of claim 14, wherein the plurality of upstream and downstream multiplexers are bi-directional.

18. The system of claim 14, wherein the plurality of upstream and downstream multiplexers each comprise a pair of uni-directional multiplexers configured jointly to provide bi-directional data flow.

19. The system of claim 14, wherein an upstream multiplexer of the plurality of upstream multiplexers has one multiplexed port corresponding to an upstream line interface circuit of the plurality of upstream line interface circuits, and a number of demultiplexed ports equal to the number of the plurality of downstream multiplexers.

20. The system of claim 14, wherein the a downstream multiplexer of the plurality of downstream multiplexer has a number of demultiplexed ports equal to the number of the plurality of the upstream multiplexers, and one multiplexed port corresponding to a downstream line interface circuit.

21. The system of claim 1, wherein the automated cross connect switch comprises a time domain multiplexer switch, wherein the time domain multiplexer switch comprises at least one upstream serializer, at least one downstream serializer, and a time division multiplexed bus.

22. The system of claim 21, wherein the at least one upstream serializer is connected to corresponding ones of the plurality of upstream line interface circuits and the at least one downstream serializer is connected to corresponding ones of the plurality of downstream line interface circuits, and wherein the at least one upstream serializer and at least one downstream serializer are connected to a time division multiplexed bus.

23. The system of claim 21, wherein the at least one upstream serializer and at least one downstream serializer transmit data from the plurality of upstream line interface circuits and plurality of downstream line interface circuits onto the time division multiplexed bus.

24. The system of claim 21, wherein at least one upstream serializer transmits during upstream time slots, and is configured to read downstream time slot data from a plurality of downstream time slots and responsively provide the downstream time slot data to a corresponding upstream line interface circuit.

25. The system of claim 21, wherein the at least one downstream serializer transmits during downstream time slots, and is configured to read upstream time slot data from appropriate upstream time slots, and responsively provide the upstream time slot data from the appropriate upstream time slot to a corresponding downstream line interface circuit.

26. The system of claim 21, wherein a routing controller configures the at least one upstream serializer and at least one downstream serializer to read data from appropriate time slots.
